(19) United States
(12) Patent Application Publication
(10) Pub. No.: US 2020/0063478 A1
(43) Pub. Date: Feb. 27, 2020

(54) SECURING SYSTEM

(71) Applicant: DR. HAHN GMBH & CO. KG, MOENCHENGLADBACH (DE)

(72) Inventors: DOMINIK NEETEN, MOENCHENGLADBACH (DE); MARKUS LENZE, NETTETAL (DE)

(73) Assignee: DR. HAHN GMBH & CO. KG, MOENCHENGLADBACH (DE)

(21) Appl. No.: 16/466,038

(22) PCT Filed: Dec. 19, 2016
(86) PCT No.: PCT/EP2016/081782

§ 371 Date: Jun. 3, 2019

(51) Int. Cl. E05D 5/02

(52) U.S. Cl. CPC E05D 5/023; F16B 2/04; E05D 5/0238

(57) ABSTRACT

A fastening system includes a profile with a groove, a fastening piece, at least two clamping pieces, and at least two fasteners. Each of the at least two fasteners act in a direction of force and cooperate with the at least two clamping pieces. The profile provides a first contact surface for each of the at least two clamping pieces. The fastening piece provides a second contact surface for each of the at least two clamping pieces.

### CROSS REFERENCE TO PRIOR APPLICATIONS

This application is a U.S. National Phase application under 35 U.S.C. § 371 of International Application No. PCT/EP2016/081782, filed on Dec. 19, 2016. The International Application was published in German on Jun. 28, 2018 as WO 2018/113906 A1 under PCT Article 21(2).

### FIELD

The present invention relates to a fastening system having a profile.

### BACKGROUND

Such fastening profiles have previously been described. They are used, for example, to connect a fitting part, which may be the part of a band for connecting, for example, a door leaf having a frame, to a profile.

A disadvantage of known fastening systems is that they are often not as easy to assemble as desired and/or fail to provide a desirably resilient fastening of the fastening piece to the profile and/or are expensive to manufacture.

### SUMMARY

An aspect of the present invention is to provide a fastening system which improves on one of the aforementioned disadvantages.

In an embodiment, the present invention provides a fastening system which includes a profile comprising a groove, a fastening piece, at least two clamping pieces, and at least two fasteners. Each of the at least two fasteners are configured to act in a direction of force and to cooperate with the at least two clamping pieces. The profile provides a first contact surface for each of the at least two clamping pieces. The fastening piece provides a second contact surface for each of the at least two clamping pieces.

### BRIEF DESCRIPTION OF THE DRAWINGS

The present invention is described in greater detail below on the basis of embodiments and of the drawings in which:

FIG. 1 shows a cross-sectional view of a first exemplary embodiment of a system according to the present invention in the not yet assembled and the not yet joined state of the profile and of the fastening piece;

FIG. 2 shows a representation as in FIG. 1 in the already joined, but not yet fastened state;

FIG. 3 shows a representation as in FIG. 1 in the already joined and fastened state;

FIG. 3a shows a detail of FIG. 3 on a slightly larger scale;

FIG. 4 shows a clamping piece in a first view;

FIG. 5 shows a clamping piece in a second view;

FIG. 6 shows a clamping piece in a third view;

FIG. 7 shows a perspective view of a clamping piece on an enlarged scale;

FIG. 8 shows another exemplary embodiment in a perspective view and on a larger scale;

FIG. 9 shows a cross-sectional view of a further exemplary embodiment of a system according to the present invention in the not yet assembled and the not yet joined state of the profile and of the fastening piece;

FIG. 10 shows a representation as in FIG. 9 in the already joined, but not yet fastened state;

FIG. 11 shows a representation as in FIG. 9 in the joined and fastened state;

FIG. 12 shows a detail of FIG. 11 on a slightly larger scale;

FIG. 13 shows one of the two clamping pieces shown in FIG. 9 in a first view;

FIG. 14 shows one of the two clamping pieces shown in FIG. 9 in a second view;

FIG. 15 shows one of the two clamping pieces shown in FIG. 9 in a third view;

FIG. 16 shows a side view as in FIG. 13, but from the opposite side;

FIG. 17 shows one of the two clamping pieces shown in FIG. 9 on an enlarged scale; and

FIG. 18 shows a representation as in FIG. 17, but with a view of the other side.

### DETAILED DESCRIPTION

The fastening system according to the present invention has a profile. A fastening piece is also provided, as well as at least two clamping pieces. The fastening system also comprises at least two fasteners, each acting in a direction of force, which interact with the clamping pieces. The profile provides first contact surfaces for the clamping pieces and the fastening piece provides second contact surfaces for the clamping pieces.

The profile can, for example, also provide at least one contact surface, for example, at least two contact surfaces, for the fastening piece.

The fastening piece can, for example, have at least one projection which engages behind a contact surface of the profile for the fastening piece. Two projections can, for example, be provided, which can further, for example, each engage behind a contact surface of the profile for the fastening piece. A condition is thereby created which enables the stability of the profile to be increased by, for example, avoiding a spreading of the profile. This contact surface of the profile for the fastening piece can, for example, also be referred to as a fastening piece contact surface.

The term “engaging behind” in the context of the present invention in particular means encompassing, for example, in such a way that tensile forces may be produced by the fastening piece on the profile.

The profile includes a groove. This groove can, for example, also be referred to as a main groove. The profile can, for example, further include at least one edge groove differing from the main groove, which is situated on a side wall of the groove. The opening of the edge groove can, for example, face, with respect to the main groove, not to the inside, but to the outside. The opening of the edge groove can, for example, face away from the groove bottom of the main groove. The at least one projection can, for example, engage in the at least one edge groove. Because the projection of the fastening piece can, for example, engage in an outwardly opening edge groove of the profile, it is possible to place the fastening piece from the outside onto the profile, thereby facilitating the assembly.

The two side walls of the at least one edge groove can, for example, be situated parallel to one another and can, for example, also be parallel to the side walls of the main groove. The profile can, for example, include at least two, and, for example, exactly two opposing edge grooves differing from the main groove, each of which can, for example, be situated on a side wall of the main groove, and whose opening in each case can, for example, face the outside of the profile. Each projection can, for example, engage in exactly one edge groove.

The fastening piece contact surface can, for example, therefore be provided by an edge groove, and specifically, for example, by a side of a wall of the edge groove facing the inside of the edge groove.

The fastening piece is situated, relative to the main groove, for example, further outward than the clamping pieces.

The fastening piece can, for example, be shaped so that it introduces forces into the profile which prevent a spreading of the main groove. The load capacity of the profile and of the fastening system can thereby be increased. The forces that prevent a spreading of the groove can, for example, be introduced into the profile by the fastening piece via the at least one projection, for example, the projections, of the fastening piece.

The fastening piece can, for example, be shaped so that it introduces forces into the profile which prevent a compression of the main groove. The load capacity of the profile and of the fastening system can thereby be increased. The forces that prevent a compression of the main groove can, for example, be introduced by the fastening piece into the profile via the clamping pieces.

In an embodiment, forces that prevent a compression of the main groove can, for example, be introduced by the fastening piece into the profile via the projections of the fastening piece.

In an embodiment, no forces preventing a compression of the main groove can, for example, be introduced by the fastening piece into the profile via the at least one projection of the fastening piece. This has the advantage that the projection does not, for example, abut or abuts only one of the two groove walls of the edge groove in which it, for example, engages and therefore, for example, the width of the projection does not need to be highly accurately adapted to the width of the edge groove.

The at least one projection of the fastening piece can, for example, rest on the groove bottom of the at least one edge groove. Both projections of the fastening piece in each case can, for example, rest on the groove bottom of the associated edge groove. The side walls of the at least one edge groove can, for example, run parallel to one another. The side walls of the at least one edge groove can, for example, run perpendicular to the groove bottom of the at least one edge groove.

The fastening piece can, for example, bridge the opening of the groove. No additional component bridging this groove opening is, for example, provided for fastening the fastening piece to the profile, for example, at least no additional rigid component. This means, for example, that (for example, with the exception of the fastening piece) no further element is provided which transfers forces from one side wall of the main groove to the other side wall of the main groove.

The fastening piece can, for example, have at least one fastening piece groove, for example, at least two or exactly two. The profile advantageously engages in the fastening piece groove. One side wall each of the edge groove can, for example, engage in the fastening piece groove. In the assembled state of the fastening piece on the profile, the walls of the fastening piece groove extend advantageously parallel to the walls of the at least one edge groove of the profile, and the opening of the fastening piece groove faces inwardly relative to the main groove of the profile. The resilience of the connection between the fastening piece and profile can thereby be further increased.

The at least one contact surface of the profile advantageously extends parallel to the side walls of the groove. The fastening piece contact surface can, for example, extend perpendicularly to the plane of the opening of the main groove and, for example, parallel to the direction of force of the fasteners.

The edge groove can, for example, be formed by an “L”-shaped projection, which can, for example, originate from a side wall of the main groove. Sections of both side walls of the main groove thus each form, for example, simultaneously, a side wall of the edge grooves.

An elastic element can, for example, be provided, which acts on the clamping pieces.

The system is used to fasten the fastening piece to the profile.

A particularly easy assembly of the fastening system may be provided as a result of the elastic element.

The fastening piece may be a band part. In an embodiment, it is not a band part. In an embodiment, it is a fitting part not used for fastening a band.

The fastening system advantageously comprises exactly one elastic element. The elastic element can, for example, act on both clamping pieces.

The fasteners each advantageously comprise a fastening screw or are formed by a fastening screw. It is also conceivable that the fasteners comprise a rivet, such as a blind rivet, or are respectively formed thereby. Exactly one fastener can, for example, cooperate with exactly one clamping piece. Each clamping piece can, for example, have a threaded hole for this purpose.

The effect of the elastic element on the clamping pieces may be mediated by another element or other elements, such as the one or multiple fasteners. The elastic element can thus act on the one or on the multiple fasteners, the one or the multiple of which can transmit this effect onto the clamping pieces.

The profile can, for example, comprise aluminum.

The clamping pieces can, for example, comprise harder material than the profile. In an embodiment, the clamping pieces can, for example, comprise steel.

The fasteners can, for example, pass through the fastening piece.

If the elastic element acts between the clamping pieces, then an advantageous assembly of the system can be achieved in a particularly simple and effective manner. The elastic element advantageously elastically draws the clamping pieces together.

The second contact surfaces can, for example, comprise slanted guide surfaces for the clamping pieces. The guide surfaces are advantageously slanted so that they do not extend parallel and, for example, also not perpendicularly to the direction of force of the fasteners. The distance of the guide surfaces (in the assembled state of the system) can, for example, increase with an increasing depth into the profile, in each case to the fastener, which cooperates with the clamping piece, for which the guide surfaces provide a contact surface. The guide surfaces can be planar or curved. If they are curved, they can, for example, be convex.

The term “force direction of the fasteners” in the context of the present invention in particular means the direction of the main force produced by these fasteners, for example, in the fully assembled state of the system. In the case of fastening screws, this in particular means the direction from their axis, which is directed toward the fastening piece, for example, in the fully assembled state of the system. The force direction in the mounted state of the system can, for example, extend perpendicularly to the imaginary plane in which the opening of the groove of the profile is situated.

The clamping pieces are each advantageously wedge-shaped on their side facing the second contact surface. The clamping pieces can thus, for example, each have a slanted counter guide surface on their side facing the second contact surface. The counter guide surface is advantageously slanted so that it does not extend parallel and, for example, also not perpendicularly to the direction of force of the fasteners. A displaceability of the clamping pieces from an assembly position to a holding position can thereby be improved.

A precondition may also be advantageously created for producing clamping forces and/or spreading forces via the clamping pieces. The slanted counter guide surface may comprise or be formed by teeth, such as splined teeth.

The system can be particularly easy to assemble if the elastic element is designed so that it provides the positioning of the clamping pieces relative to each other in an assembly position. The elastic element in this embodiment is namely able to relieve the assembler of the task of holding the clamping pieces in an assembly position, for example, when joining the fastening piece to the profile.

If the elastic element allows the clamping pieces to be displaced into a holding position, this then creates another precondition for a particularly easy assembly of the system. The assembler in this case not need, for example, remove the elastic element, for example, after joining the fastening piece to the profile. The elastic element allows the clamping pieces to be, for example, displaced as the fasteners are fastened in a holding position.

The term “assembly position of the clamping pieces” within the context of the present invention in particular refers to the position of the clamping pieces (for example, relative to each other) in the unassembled state, which enables and/or facilitates the joining of the fastening piece to the profile.

The term “holding position of the clamping pieces” within the context of the present invention in particular means the position of the clamping pieces, which these occupy in the fully assembled state of the fastening system.

The profile advantageously includes a groove. The first contact surfaces can, for example, be provided by side walls of this groove. The two clamping pieces are advantageously situated next to one another in this groove in the assembled state of the system. These two clamping pieces in the assembled state are thus, for example, situated not next to each other in the longitudinal direction of the profile, but perpendicularly thereto.

The distance between the two clamping pieces in the assembly position relative to each other can, for example, be smaller than the width of the opening of the groove, so that these clamping pieces are advantageously easily insertable into the groove in the assembly direction of the joining of the clamping piece and the profile.

The distance of at least sections of two clamping pieces situated next to each other in the groove in their holding position is advantageously larger than the width of the opening of the groove. An interaction between the clamping pieces located in their holding position and the groove, such as a rear grip, is thereby, for example, possible.

The second contact surfaces are advantageously designed so that with their help, the displacement of the clamping pieces from an assembly position into a holding position may be provided by fastening the fasteners. This displacement may advantageously be provided only by fastening the fasteners. With this displacement, the distance of the clamping pieces relative to each other advantageously changes, it can, for example, increase. With this displacement, a tilting of the clamping pieces advantageously takes place, for example, so that the distance of the sections of the clamping pieces that are further away from the fastening piece increases more than the distance of the sections of the clamping pieces that are situated closer to the fastening piece. The term “fastening of the fasteners” means, for example, in the case of a screw as a fastener, the tightening thereof, for example, until this screw produces the desired main force (here tractive force). A simplification of the assembly is achieved insofar as the displacement may, for example, be provided by fastening the fasteners, for example, no further action is necessary for this purpose.

In an embodiment, the clamping pieces can, for example, include teeth. The longitudinal extension of the teeth is advantageously parallel to the direction of force of the fasteners. The teeth can, for example, have a wedge-shaped outer contour, for example, so that they protrude farther from the clamping pieces in sections further away from the fastening piece than in sections situated closer to the fastening piece.

The wedge shape of the clamping pieces can be wholly or partially produced by the teeth. In an embodiment, therefore, the clamping pieces as such are not, for example, each already wedge-shaped, but acquire this shape only through the teeth.

As a result of the teeth, a positive connection may be advantageously produced. The positive connection can, for example, act between the clamping pieces and the fastening piece and, for example, further between the clamping pieces and the profile. The positive connection can thus, for example, act between the fastening piece and the profile, for example, mediated by a clamping piece.

In the assembled state, the teeth can, for example, engage in the second contact surface. In an embodiment, the teeth in the assembled state can, for example, engage in the first contact surface. Furrows, with which the teeth advantageously form-fittingly interlock, may be produced in the first contact surfaces and/or the second contact surfaces by fastening the fasteners via the teeth.

In an embodiment, holders for the elastic element can, for example, be provided on the clamping pieces. The elastic element can be a ring made of elastic material, for example, a rubber ring, for example, a so-called O-ring. The holders may include projections on which the elastic element may rest. The projections may be situated in recesses of the clamping pieces, for example, so that they do not project beyond the outer contour of the clamping pieces. The recesses of the clamping pieces can face each other. The holders may have heads against slippage of the elastic member.

In an embodiment, the clamping pieces can, for example, each be wedge-shaped on two opposite sides and/or the first and second contact surfaces extend towards each other in the direction of the force. A precondition can thereby be created for providing that the clamping pieces (advantageously in their holding position) each produce spreading forces between a first contact surface and a second contact surface.

The spreading force can be produced exclusively or partially by the teeth, in particular in an embodiment in which the wedge shape of the clamping pieces is wholly or partially produced by the teeth.

A frictional connection may be advantageously produced between the clamping pieces and the first contact surfaces and, for example, between the clamping pieces and the second contact surfaces. A frictional connection may therefore, for example, be produced between the fastening piece and the profile, for example, mediated by a clamping piece. The force flow of this frictional connection advantageously does not flow through the fastener. A relieving of the fasteners may be achieved as a result.

A relative movement between the teeth of the clamping pieces and the contact surfaces may be advantageously produced during the fastening of the fasteners, for example, also when the teeth are already in contact with the contact surfaces. A furrow of the teeth may be advantageously produced in the contact surfaces as a result. The teeth advantageously have a tapered outer contour, resulting in a particularly good furrow effect.

In an embodiment, sections of the first contact surfaces can, for example, extend parallel to the direction of force of the fasteners, or the first contact surfaces extend completely parallel to the direction of force of the fasteners. It has been found that also with such contact surfaces, the clamping pieces may be fixed in the direction of the force direction of the fasteners.

It is in principal conceivable that sections of the second contact surfaces extend parallel to the direction of force of the fasteners, or the second contact surfaces extend completely parallel to the direction of force of the fasteners.

In an embodiment, the fastening piece can, for example, have at least one projection which engages behind a contact surface of the profile extending parallel to the force direction of the fasteners. The projection also advantageously extends parallel to the direction of force of the fasteners. The fastening piece thus advantageously engages behind the profile sections which provide these surfaces. Spreading forces of the clamping piece can thereby be supported and/or these sections of the profile may be pinched between the clamping piece and the projection of the fastening piece.

In an embodiment, the clamping pieces can, for example, have a shoulder, in particular in their holding position, on their side facing the first contact surface.

The shoulder can, for example, also be referred to as a nose or a projection.

In this embodiment, in particular, at least sections of the first contact surface advantageously extend perpendicularly to the direction of force of the fasteners. The shoulder advantageously engages behind these sections in the holding position of the clamping pieces. The clamping pieces may also have teeth in this embodiment, in particular, on their sides facing the second contact surfaces and/or on their sides facing the first contact surfaces.

In an embodiment, the wedge angle of the wedge shape of the clamping pieces can, for example, be less than 45°.

In an embodiment, the clamping pieces can, for example, have teeth on different, for example, on opposite, sides.

In an embodiment, the clamping pieces can, for example, have different teeth. The clamping pieces can, for example, have different teeth on different sides. The different requirements for the teeth advantageously prevailing on different sides of the clamping pieces can thereby be taken into account.

First teeth can, for example, be provided on one side of the clamping pieces (for example, the side facing the second contact side in the assembled state) the longitudinal extension of which extends advantageously parallel to the direction of force of the fasteners, and which further, for example, have a wedge-shaped outer contour, for example, so that they project further from the clamping pieces in sections further away from the clamping piece than in sections situated closer to the fastening piece. These first teeth advantageously produce or maintain the wedge shape of the clamping pieces, for example, implemented on this side of the clamping pieces. These first teeth can further, for example, produce spreading forces, or the displacement of the clamping pieces from the assembly position into the holding position is accomplished with their assistance. The first teeth may also be referred to as “splined teeth”.

On another, for example, the opposite, and, for example, on the side of the clamping pieces which includes a shoulder, the clamping pieces advantageously have second teeth which do not produce or maintain a wedge shape of the clamping pieces. These second teeth can, for example, originate from the shoulder of the clamping pieces, more specifically, for example, from the surface of the shoulder, with which the shoulder engages behind at least sections of the first contact surface, which advantageously extend perpendicularly to the direction of force of the fasteners. These second teeth advantageously point in the direction of the force direction of the fasteners. When fastening the fasteners, these second teeth are advantageously moved perpendicularly toward this first contact surface and can further, for example, be embedded in this contact surface. A positive connection and/or frictional connection is/are thereby produced between the clamping piece and the profile. The second teeth may also be referred to as “vertical teeth”.

In an embodiment, the clamping pieces can, for example, have teeth on one side (for example, on the side facing the second contact surface) which advantageously produce or maintain a wedge shape of the clamping pieces on this side of the clamping pieces. These teeth may be splined teeth. The clamping pieces can further, for example, have a shoulder on the opposite side, which, for example, engages behind sections of the first contact surface, which further, for example, extend perpendicularly to the direction of force of the fasteners. The following advantage among others can thereby be achieved: the clamping pieces may be reliably displaced from the assembly position into the holding position and secured in the holding position with the aid of the teeth producing or maintaining the wedge shape, without a defined stop for the clamping pieces being provided on the fastening piece in the direction of force of the fasteners. This is because teeth producing or maintaining the wedge shape are able to push slightly further or less far into the fastening piece depending on manufacturing tolerances. It can thereby be provided that the force exerted by the fasteners on the clamping pieces is transmitted to a very large extent via the shoulder onto the profile where it results in the desired clamping. It has been found that to achieve this effect, it is helpful if, for example, the wedge angle of the wedge shape of the clamping pieces is less than 45°. As previously stated above, teeth, such as vertical teeth, can also be provided on the shoulder.

In an embodiment, the clamping pieces can, for example, abut the second contact surfaces both in their assembly position, as well as in their holding position.

In an embodiment, the clamping pieces can, for example, abut the second contact surfaces only in their assembly position and are supported in their holding position merely on the first contact surfaces.

In an embodiment, the clamping pieces can, for example, each be wedge-shaped on their side facing the second contact surface.

If the clamping pieces are each wedge-shaped on their side facing the second contact surface, then the clamping pieces can, for example, each have a slanted counter guide surface on their side facing the second contact surface. The counter guide surface is advantageously slanted so that it does not extend parallel and, for example, also not perpendicularly to the direction of force of the fasteners. A displaceability of the clamping pieces from an assembly position to a holding position can thereby be improved.

A precondition may also be advantageously created for producing clamping forces and/or spreading forces via the clamping pieces. The slanted counter guide surface may comprise or be formed by teeth, such as splined teeth.

The clamping pieces can each be wedge-shaped on two opposite sides and/or the first and second contact surfaces can extend toward one another in the direction of the force. A precondition can thereby be created for providing that the clamping pieces, advantageously in their holding position, each produce spreading forces between a first contact surface and a second contact surface.

The present invention will now be explained in greater detail below under reference to two exemplary embodiments as shown in the drawings.

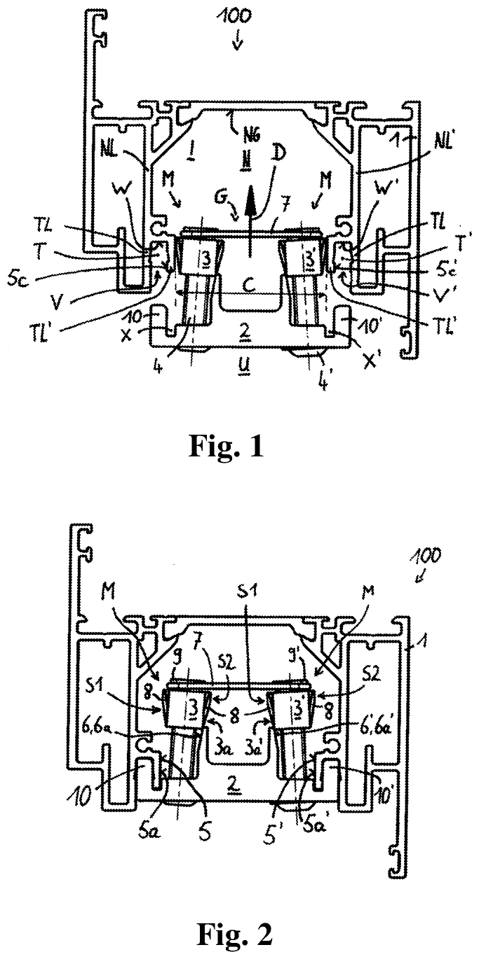

FIGS. 1-3 show a first exemplary embodiment of a system according to the present invention identified as a whole by 100.

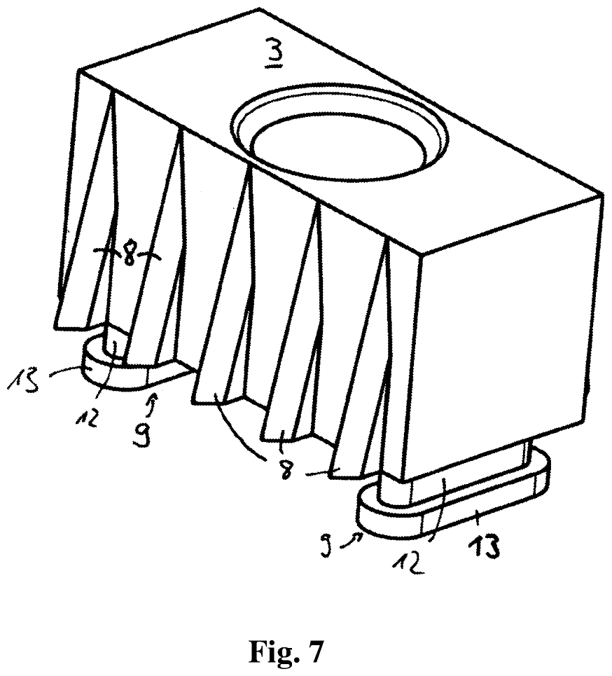

FIGS. 1-9 show the assembly direction D of the joining of the fastening piece 2 and the profile 1 and the width C of the opening G of the groove N of the profile 1. This groove N can also be referred to as the main groove.

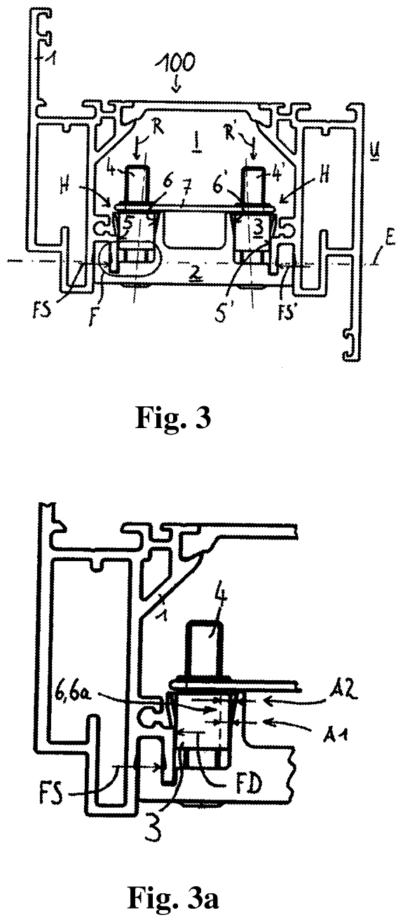

All exemplary embodiments of the system according to the present invention shown comprise a profile 1 and a fastening piece 2. All exemplary embodiments shown also comprise exactly two clamping pieces 3, 3′ and exactly two fasteners 4, 4′, which cooperate with the clamping pieces 3, 3′ and which are designed as fastening screws. The fastening screws in all exemplary embodiments shown cooperate with threaded holes 3c of the clamping pieces 3, 3′. The force direction R, R′ in all exemplary embodiments shown in the assembled state of the system 100 extends perpendicularly to the imaginary plane E, in which the opening G of the groove N of the profile 1 is located. In all exemplary embodiments shown, the profile 1 provides first contact surfaces 5, 5′ for the clamping pieces 3, 3′, which are abutted by the clamping pieces 3, 3′ in their holding position H (see FIGS. 3, 6 and 14). In all exemplary embodiments, second contact surfaces 6, 6′ are additionally provided on the fastening piece 2 for the clamping pieces 3, 3′.

All exemplary embodiments shown also comprise an elastic element 7 which acts between the clamping pieces 3, 3′ and which elastically draws the clamping pieces toward each another.

The second contact surfaces 6, 6′ comprise slanted guide surfaces 6a, 6a′ in all exemplary embodiments, and the clamping pieces 3, 3′ are each wedge-shaped on their side 3a, 3a′ facing the second contact surface 6, 6′.

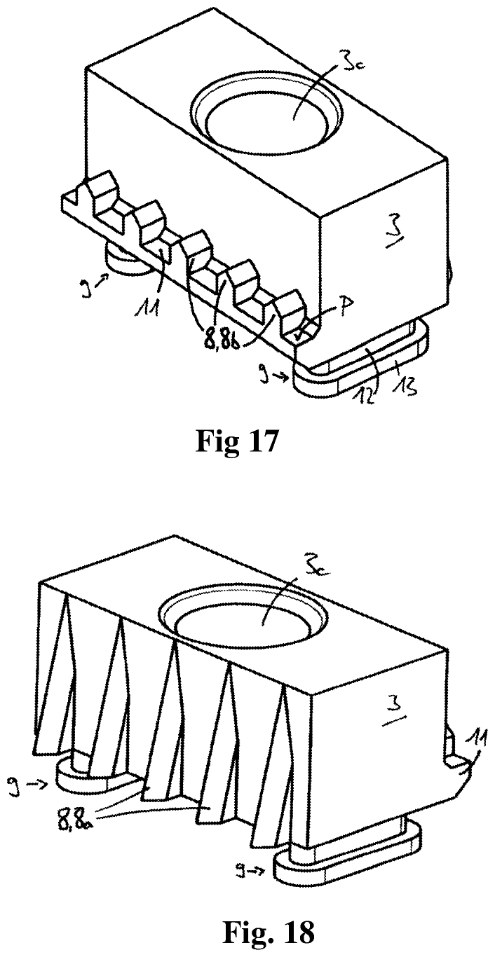

In the exemplary embodiments shown in FIGS. 1-7 and 9-18, the slanted guide surfaces are planar; they are convex in the exemplary embodiment shown in FIG. 8.

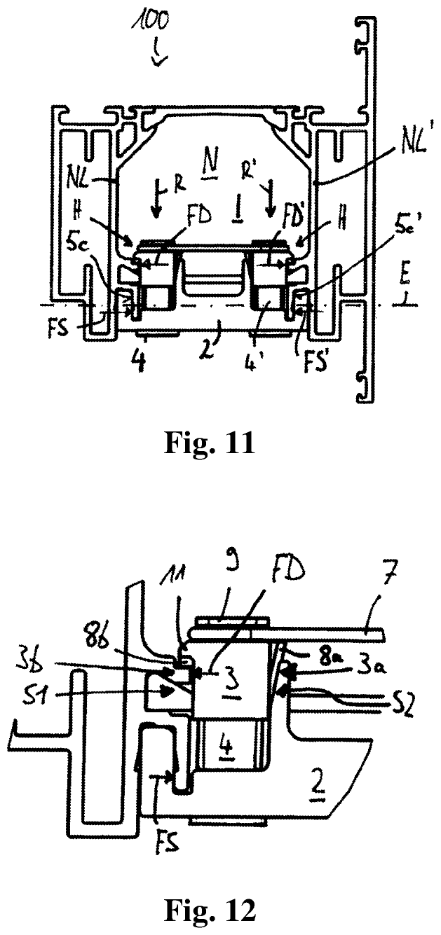

The elastic element 7 in all exemplary embodiments is designed so that it causes the clamping pieces 3, 3′ to be positioned relative to each other in an assembly position M and allows the displacement of the clamping pieces into a holding position H. This displacement in all exemplary embodiments is provided by the fact that, starting from the position in FIG. 2 or 10, the fasteners 4, 4′are fastened, i.e., the fastening screws are tightened (see FIGS. 2 and 3, or FIGS. 10 and 11).

The second contact surfaces 6, 6′ are designed so that with their help, the displacement of the clamping pieces 3, 3′ from the assembly position M into the holding position H may be provided by fastening the fasteners 4, 4′. As a comparison of FIGS. 2 and 3 and FIGS. 10 and 11 shows, the distance between the clamping pieces 3, 3′ increases with this displacement and a tilting of the clamping pieces 3, 3′ takes place.

When tightening the fastening screws, the clamping pieces 3, 3′ slide along on the second contact surfaces 6, 6′, which causes an increase in the distance between the two clamping pieces relative to each other and a tilting of the clamping pieces 3, 3′.

As shown, for example, in the first exemplary embodiment, the clamping pieces 3, 3′ of all exemplary embodiments shown may have teeth 8. The teeth of the exemplary embodiment shown in FIG. 8 (not shown in the drawings) may be the same as or equivalent to the teeth of the exemplary embodiment shown in FIGS. 1-7 or FIGS. 9-18.

The clamping pieces 3, 3′ of all exemplary embodiments shown can have holders 9, 9′ for the elastic element 7.

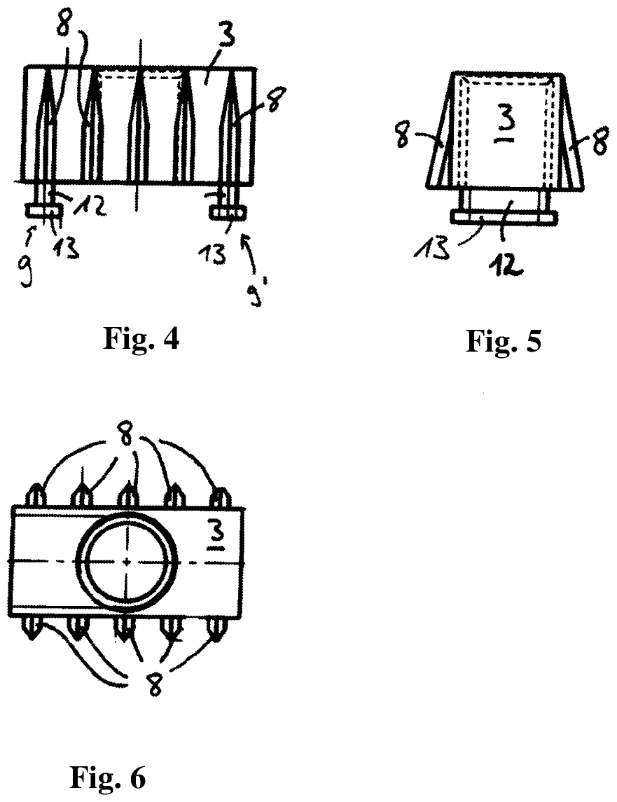

In the embodiment shown in FIGS. 1-3, the clamping pieces 3, 3′ are wedge-shaped not only on their side 3a facing the second contact surfaces 6, 6′, but also on two opposite sides S1, S2. As can be seen from the drawings, this wedge shape is caused exclusively by the teeth 8. FIGS. 4-7, for example, show that the remaining clamping piece 3 is not wedge-shaped, but cuboid-shaped. In the exemplary embodiment shown in FIGS. 1-3, at least sections of the first contact surfaces 5, 5′ extend parallel to the direction of force R, R′ of the fasteners 4, 4′, i.e., parallel to the axis of the fastening screws in their holding position H. More precisely, the first contact surfaces 5, 5′ here extend completely parallel to the direction of force R, R′ of the fasteners 4, 4′. In this exemplary embodiment, the clamping pieces 3, 3′ in their holding position H produce spreading forces between the fastening piece 2 and the profile 1. FIG. 3 shows that the force flow F of these spreading forces does not extend through the fasteners 4, 4′, i.e., the fasteners 4, 4′ are not relieved thereof and the spreading forces act directly between the fastening piece 2 and profile 1, mediated by a clamping piece 3. In this exemplary embodiment, the clamping pieces 3, 3′ in their holding position H abut the first contact surfaces 5, 5′ and the second contact surfaces 6, 6′.

FIGS. 1-3 also show that the fastening piece 2 shown in this exemplary embodiment has two projections 10, 10′, each of which engages behind a contact surface 5a, 5a′ of the profile extending parallel to the direction of force R of the fasteners 4, 4′.

More precisely, in all the exemplary embodiments shown, the fastening piece 2 has two projections 10, 10′, each of which engages behind a fastening piece contact surface 5c, 5c′ of the profile 1. A spreading of the profile 1 can thereby, for example, be avoided.

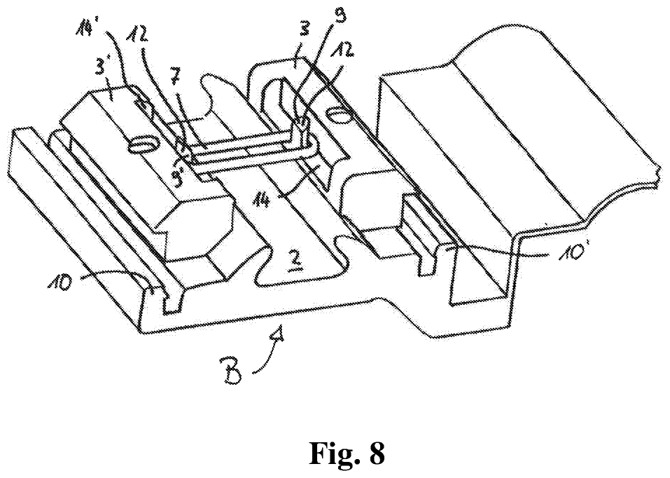

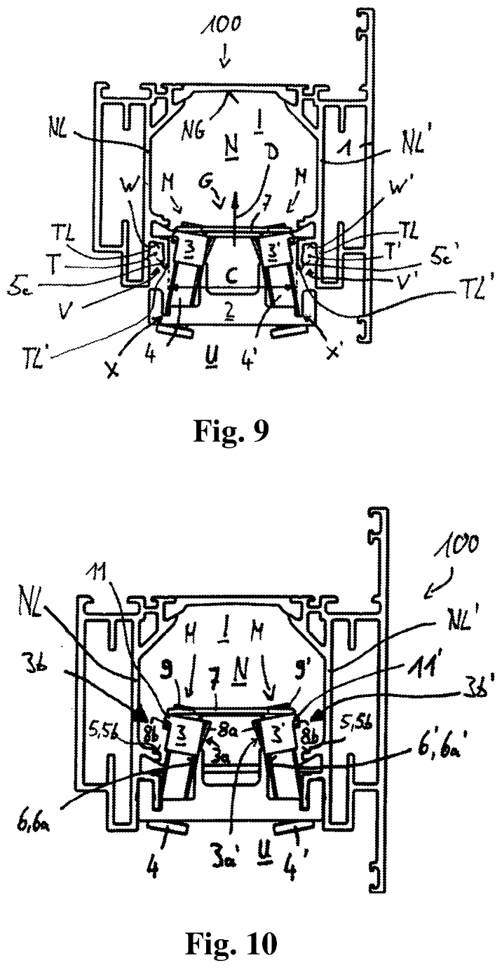

As shown for example in FIGS. 1 and 9, the profile 1 of all exemplary embodiments shown has two edge grooves T, T′, which are situated on opposite side walls NL, NL′ of the groove N. The openings V, V′ of the edge grooves T, T′ do not point inwards I relative to the main groove N, but outwardly U. The openings V, V′ of the edge groove point away from the groove bottom NG of the main groove N. Both projections 10, 10′ each engage in an edge groove T, T′. The two side walls TL, TL′ of the at least one edge groove are arranged parallel to one another and parallel to the side walls NL, NL′ of the main groove N.

The fastening piece contact surface 5c, 5c′ is thus provided by an edge groove T, T′ of the profile 1, specifically by a side of a side wall TL, TL′ of the edge groove facing the inside of the edge groove.

The fastening piece 2 is shaped so that it introduces forces FS, FS′ into the profile 1, which prevent a spreading of the main groove N. The forces FS, FS′, which prevent a spreading of the groove, are introduced from the fastening piece 2 into the profile 1 via the projections 10, 10′ of the fastening piece (see, for example, FIGS. 3, 3a and 12).

The fastening piece 2 is also shaped so that it also introduces forces FD, FD′, which prevent a compression of the main groove N, into the profile 1. The forces FD, FD′, which prevent a compression of the main groove N, are introduced into the profile 1 via the clamping pieces 3, 3′ of the fastening piece 2, see for example, FIG. 11.

The side walls TL, TL′ of the two edge grooves extend perpendicularly to the groove bottom W, W′ of the at least one edge groove T, T′.

The fastening piece 2 bridges the opening G of the groove N. No additional component bridging this groove opening G is provided for fastening the fastening piece 2 to the profile 1.

The fastening piece 2 has two fastening piece grooves X, X′, in each of which a side wall TL′ of the edge groove T, T′ engages. In the assembled state of the fastening piece 2 on the profile 1, the walls of the fastening piece groove X, X′ extend parallel to the walls TL, TL′ of the two edge grooves T, T′ of the profile 1 and the openings of the two fastening piece grooves X, X′ point inwardly I relative to the main groove N.

The fastening piece contact surface 5c, 5c′ extends perpendicularly to the plane E of the opening of the main groove N and parallel to the direction of force R, R′ of the fasteners 4, 4′ (see, for example, FIG. 11).

Both edge grooves T, T′ are each formed by an “L” -shaped projection, which originates from a side wall NL, NL' of the main groove N. Sections of both side walls of the main groove thus each simultaneously form a side wall of the edge grooves.

The fastening piece 2 in the exemplary embodiment shown in FIGS. 1-3 may be designed as a fitting part, which is not used for fastening a band.

FIG. 3a illustrates that the distance of the second contact surfaces 6, 6′ designed as slanted guide surfaces 6a, 6a′ to the fastener 4, which cooperates with the clamping piece 3, for which they provide a contact surface (in the assembled state of the system) increases from a first distance A1 with increasing depth into the profile in each case to a second distance A2.

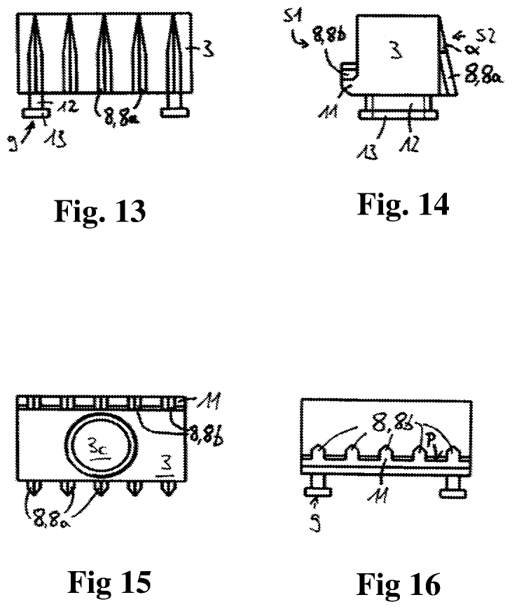

In FIGS. 4-7, one of the two clamping pieces 3, 3′ of the exemplary embodiment shown in FIGS. 1-3 is shown in greater detail. Apparent, among other things, are the holders 9, 9′ for the elastic element 7, which are formed from a projection 12 and from a head 13 of this projection. As can be seen for example in FIGS. 13, 17 and 18, the clamping pieces 3, 3′ of the exemplary embodiment shown there have such holders 9, 9′ with projection 12 and head 13.

In the exemplary embodiments shown in FIGS. 8-18, the clamping pieces 3, 3′ are wedge-shaped only on their side 3a, 3a′ facing the second contact surfaces 6, 6′. They have a shoulder 11 on the opposite side, i.e., on the sides 3b, 3b′ facing the first contact surfaces 5, 5′.

The first contact surfaces 5, 5′ in these exemplary embodiments are designed so that at least sections 5b, 5b′ extend perpendicularly to the direction of force R of the fasteners 4, 4′. As shown, for example, in FIGS. 10 and 11, the shoulders 11 in the holding position H of the clamping pieces 3, 3′ engage behind these sections 5b, 5b′ of the first contact surfaces 5, 5′, which extend perpendicularly to the direction of force R, R′. The fastening piece 2 in the exemplary embodiment shown in FIG. 8 is designed as part of a band B. The clamping pieces 3, 3′ in this exemplary embodiment can also have teeth 8 (not shown in FIG. 8) on their sides 3a, 3a′ facing the second contact surfaces 6, 6′.

In one modification not shown in the drawings of all exemplary embodiments shown, the elastic element 7 is omitted in each case.

From FIG. 8 it is apparent for this exemplary embodiment that the clamping pieces 3, 3′ have holders 9, 9′ for the elastic element 7, with projections 12 situated in recesses 14, 14′ of the clamping pieces 3, 3′ so that they do not protrude beyond the outer contour of the clamping pieces. The recesses 14, 14′ of the clamping pieces 3, 3′ face each other.

The wedge angle α of the wedge shape of the clamping pieces 3, 3′ is, for example, less than 45° in the exemplary embodiment shown in FIGS. 9 through 18 (see, for example, FIG. 14).

In the exemplary embodiment shown in FIGS. 9 through 18, the clamping pieces 3, 3′ on the side 3a, 3a′ facing the second contact surface have spline teeth 8a, which produce a wedge shape of the clamping pieces on this side of the clamping pieces (see, for example, FIGS. 13-16). On the opposite side, the clamping pieces 3, 3′ have a shoulder 11, which engages behind the sections 5b, 5b′ of the first contact surface 5, 5′, which extend perpendicularly to the direction of force R, R′ of the fasteners 4, 4′. The result that may be achieved by this is, in particular, that the force exerted on the clamping pieces 3, 3′ by the fasteners 4, 4′ is transmitted to the profile 1 to a very large extent via the shoulder 11 where it results in the desired clamping (see, for example, FIG. 12).

In the exemplary embodiment shown in FIGS. 9-18, the clamping pieces 3, 3′ have teeth 8 on opposite sides S1, S2. The teeth 8 on opposite sides S1, S2 are different from each other.

On one side of the clamping pieces, specifically, the side 3a, 3a′ facing the second bearing surface 6, 6′ in the assembled state, spline teeth 8a are provided, the longitudinal extent of which extends parallel to the direction of force R, R′ of the fasteners 4, 4′, and which have a wedge-shaped outer contour, so that in sections further away from the fastening piece 2 they project further from the clamping pieces 3, 3′ than in sections situated closer to the fastening piece 2. These wedge teeth 8a produce the wedged shape of the clamping pieces 3, 3′ implemented on this side of the clamping pieces 3, 3′, and they produce spreading forces or, with their help, the clamping pieces 3, 3′ are displaced from the assembly position M into the holding position H.

On the opposite side, specifically, on the side of the clamping pieces 3, 3′ that includes a shoulder 11, the clamping pieces 3, 3′ advantageously have vertical teeth 8b, which produce no wedge shape of the clamping pieces. These perpendicular teeth 8b originate from the shoulder 11 of the clamping pieces, more precisely, from the surface P of the shoulder 11, with which it engages behind at least sections of the first contact surface 5b, 5b′, which extend perpendicularly to the direction of force R, R′ of the fasteners 4, 4′. These vertical teeth 8b point in the direction of the force direction R, R′ of the fasteners 4, 4′. When fastening the fasteners 4, 4′, these perpendicular teeth 8b are moved perpendicularly toward this first contact surface 5b, 5b′ and embed themselves in this contact surface.

The present invention is not limited to embodiments described herein; reference should be had to the appended claims.

### LIST OF REFERENCE NUMERALS

100 Fastening system

1 Profile

2 Fastening piece

3, 3′ Clamping pieces

3a, 3a′ Side of the clamping pieces facing the second contact surface

3b, 3b′ Side of the clamping pieces facing the first contact surface

3c Threaded hole

4, 4′ Fasteners

5, 5′ First contact surfaces

5a, 5a′ First contact surfaces extending parallel to the direction of force

5b, 5b′ First contact surfaces extending perpendicularly to the direction of force

5c, 5c′ Fastening piece contact surfaces

6, 6′ Second contact surfaces

6a, 6a′ Guide surfaces

7 Elastic element

8 Teeth

8a Splined teeth

8b Vertical teeth

9, 9′ Holders

10, 10′ Projection of the fastening piece

11, 11′ Shoulder

12 Projection

13 Head

14, 14′ Recesses

A1 Distance

A2 Distance

B Band

C Width of the opening of the groove

D Assembly direction

E Imaginary plane in which the opening of the groove lies

G Opening of the groove

F Force flow

FS, FS′ Forces preventing a spreading of the profile

FD, FD′ Forces preventing a compression of the profile

H Hold position

I Inside (relative to the main groove)

M Assembly position

N Groove

NG Groove bottom of the main groove

NL, NL′ Sidewall of the groove

P Area of the shoulder

R, R′ Force direction

S1, S2 Opposite sides of the clamping piece

T, T′ Edge grooves

TL, TL′ Side wall of the edge groove

U Outside (relative to the main groove)

V, V′ Opening of the edge grooves

W, W′ Groove bottom of the edge groove

X, X′ Fastening piece groove

α Wedge angle

What is claimed is:

1-12. (canceled)

13. A fastening system comprising:
a profile comprising a groove;
a fastening piece;
at least two clamping pieces; and
at least two fasteners, each of which are configured to act in a direction of force and to cooperate with the at least two clamping pieces,
wherein,
the profile provides a first contact surface for each of the at least two clamping pieces, and
the fastening piece provides a second contact surface for each of the at least two clamping pieces.

14. The fastening system as recited in claim 13, wherein,
the groove comprises an opening,
the fastening piece is configured to bridge the opening of the groove to as to fasten the fastening piece on the profile, and
no additional component bridging the opening of the groove is provided to fasten the fastening piece on the profile.

15. The fastening system as recited in claim 13, wherein,
the profile further provides at least one contact surface for the fastening piece, and
the fastening piece comprises at least one projection which is configured to engage behind the at least one contact surface.

16. The fastening system as recited in claim 15, wherein,
the profile further comprises at least one edge groove which is arranged on a side wall of the groove and an opening which opens outwards and not inwards relative to the groove, and
the at least one projection of the fastening piece engages in the at least one edge groove.

17. The fastening system as recited in claim 15, wherein,
the fastening piece is configured to introduce forces, which prevent a spreading of the groove, into the profile via the at least one projection, and
the at least one clamping piece is configured to introduce forces, which prevent a compression of the groove, from the fastening piece into the profile and not via the at least one projection.

18. The fastening system as recited in claim 16, wherein,
the at least one edge groove of the profile comprises a side wall, and
the fastening piece further comprises one fastening piece groove which is configured to have the side wall of the at least one edge groove engage therein.

19. The fastening system as recited in claim 16, wherein the at least one contact surface of the profile for the fastening piece extends parallel to the side wall of the groove.

20. The fastening system as recited in claim 13, further comprising:
an elastic element which is configured to act on each of the at least two clamping pieces.

21. The fastening system as recited in claim 13, wherein the at least two clamping pieces are each configured to have a wedge-shape arranged on a side which faces the second contact surface.

22. The fastening system as recited in claim 13, wherein each of the at least two clamping pieces comprise a shoulder on a side which faces the first contact surface.

23. The fastening system as recited in claim 13, wherein each of the at least two clamping pieces comprise teeth.

24. The fastening system as recited in claim 23, wherein,
the teeth of the at least two clamping pieces are arranged on a first side which faces the second contact surface, the teeth being configured to produce or to maintain a wedge-shape of the at least two clamping pieces on the first side, and
the each of the at least two clamping pieces further comprise a shoulder on a second side which is opposite to the first side.
